(19) United States
(12) Patent Application Publication
(10) Pub. No.: US 2002/0163685 A1
(43) Pub. Date: Nov. 7, 2002

(54) System and method for routing working and protect paths

(76) Inventor: Eric Arthur Swanson, Acton, MA (US)

Correspondence Address: LAHIVE & COCKFIELD, 28 STATE STREET, BOSTON, MA, 02109, US

(21) Appl. No.: 09/847,091

(22) Filed: May 1, 2001

(51) Int. Cl. H04B 10/08; H04B 10/12

(52) U.S. Cl. 359/110; 359/173

(57) ABSTRACT

A method and apparatus for providing an optical networking scheme that provides working and protect paths to address failures of optical lines and components, is provided. An optical sub-assembly has an optical signal separated into a first sub-band and a second sub-band. A working path propagates through the optical network. The working path operates only in the first sub-band. A protect path propagates through the optical network, operating only in the second sub-band. A first module disposed along the working path affects the working path, and a second module disposed along the protect path affects the protect path.

### FIELD OF THE INVENTION

The invention relates to the routing of optical paths within an optical network, and more particularly to separating working and protect paths for an optical signal based on a sub-band structure of the optical channel.

### BACKGROUND OF THE INVENTION

In optical networks such as dense wavelength division multiplexing (DWDM) optical networks, optical signals undergo a variety of signal modifying actions as they traverse spans of optical fiber, which creates the potential for line or component failures to occur. Known protection schemes help to ensure that the optical signals traveling along the fiber spans successfully make the journey from an origination node to a destination node.

FIG. 1A depicts one example optical path in a conventional optical network configuration. The optical signal originates at an origination terminal 40. The signal propagates through a first amp 42, which amplifies the signal as desired. A first add/drop node 44 adds and/or drops optical channels. A second amplifier 46 once again amplifies the optical signal. The optical signal terminates at a destination terminal 48.

The length of fiber span between each of the optical modules 40, 42, 44, 46, and 48 can vary, and has an effect on the necessity for these modules. A bi-directional optical signal travels in the opposite direction to the previously described signal, such that it originates at terminal 48 and terminates at terminal 40. If there is a break in the optical fiber of the optical path illustrated, or if one of the optical modules (such as the origination terminal 40, the amplifiers 42 and 46, the add/drop node 44, or the destination terminal 48) fails, there is no recourse to salvage the optical signal without repairing the failed or broken line or module.

Those skilled in the art have devised a solution to this problem in the form of a linear transmission system with “1+1 protection”. FIG. 1B shows two paths of an optical network with the 1+1 protection scheme in place. A working path (W) and a protect path (P) originate in terminal 40. The paths W and P propagate through an amplifier 42 that amplifies the signals. A channel add/drop node 44 adds and/or drops channels relative to the paths W and P. A second amplifier 46 again amplifies the optical signal. The paths W and P terminate at a terminal 48. The working and protect paths W and P likewise travel in the opposite direction in the form of a signal from terminal 48 to terminal 40.

There is concomitantly a second working path (W′) and second protect path (P′) that originate at terminal 40′. The paths W′ and P′ propagate through an amplifier 42′. A channel add/drop node 44′ adds and/or drops channels relative to the paths W′ and P′. A second amplifier 46′ amplifies the optical signal of the paths W′ and P′, and the paths terminate at terminal 48′.

The working paths W and W′, and the protect paths P and P′, travel between both terminals 40 and 48, and terminals 40′ and 48′. Therefore, if an optical fiber break occurs between either of the terminals 40 and 48, or 40′ and 48′, or likewise a module fails along the working path W or the protect path P, such as an amplifier 42, 42′, 46, and 46′, or a channel add/drop node 44 and 44′, the other working path W′ or the other protect path P′ can take over and resume service. This arrangement has a substantial number of duplicate and repetitive fiber spans and modules, thus adding to the overall cost of the arrangement.

Another known solution is to employ span protection as illustrated in FIG. 1C. Optical signals travel from a terminal 52 to a switch 54. The switch 54 directs the optical signals to either of a first amplifier 58 and a second amplifier 60 for amplification, depending on the wavelength of the signals. The amplified signals combine back together at another switch 62. The optical signals continue through a channel add/drop node 66, which can add or drop channels relative to the optical signals. The optical signals then enter another switch 68, where the signals split and propagate to one of a third amplifier 72 and a fourth amplifier 74, depending on the wavelength of the signals. Upon leaving the amplifiers 72 and 74, the optical signals combine again at another switch 76, and terminate at terminal 80.

The optical signals can travel in the opposite direction from terminal 80 to terminal 52 as well. After originating at terminal 80, the signals pass through a switch 78, where the signals are parsed to the third amplifier 72 or the fourth amplifier 74 for amplification, depending on the wavelength of the signals. The amplified signals leave the amplifiers 72 and 74 and re-combine at switch 70. The signals exit the switch 70 and pass through the channel add/drop node 66. Upon exiting the channel add/drop node 66, the signals pass through a switch 64 and again to the first amplifier 58 or the second amplifier 60 for amplification, depending on the wavelength of the signals. The amplified signals exit the amplifiers 58 and 60, re-combine at switch 56, and terminate at terminal 52.

The configuration of FIG. 1C has optical signals traveling in both directions over both the working path and the protect path. A shadow span diversely protects each span between nodes. All of the signals from the working and protect paths, traveling in both directions, can pass through the same terminals 52 and 80, one of the amplifiers 58, 60, 72, and 74, and the same add/drop node 66. Each terminal and add/drop site shares both the working and the protect paths, thereby not incurring the additional marginal costs that arise from doubling the number of terminals as was previously the case in FIG. 1B.

There is one set of amplifiers, the first amplifier 58 and the third amplifier 72, that handle one bundle of wavelengths, and a second set of amplifiers, the second amplifier 60 and the fourth amplifier 74, that handle a different bundle of wavelengths. However, both the working and protect paths pass through the first and third amplifiers 58 and 72 for the wavelengths for which those amplifiers 58 and 72 are designed. Therefore, if one of the amplifiers 58 or 72 fails, both the working and protect paths for the set of wavelengths passing through those amplifiers 58 and 72 will also fail, and the traffic will halt.

Implementing this protection scheme requires the addition of optical switches entering and exiting the terminals and add/drop nodes. However, unlike the scheme of FIG. 1B, the arrangement of FIG. 1C does not provide protection against terminal failure, failure of the channel add/drop node, or failure of the amplifiers. In each instance, both the working and protect paths will fail if one of the modules fails. This arrangement lessens the value of the protect paths.

### SUMMARY OF THE INVENTION

There is a need for an optical networking scheme that provides working and protect paths to address failures of optical lines and components, while also reducing overall costs. The present invention is directed toward further solutions to address this need.

In accordance with one example embodiment of the present invention, an optical sub-assembly has an optical signal separated into a first sub-band and a second sub-band. A working path is provided in the optical network. The working path carries only the wavelengths from the first sub-band. A protect path is also provided in the optical network, and carries only the wavelengths from in the second sub-band. A first module disposed along the working path affects the working path, and a second module disposed along the protect path affects the protect path.

The optical network can be arranged such that the first sub-band is one of a C-band and an L-band, and the second sub-band is the other of the C-band and L-band.

The optical network can include a number of different modules, including optical amplifiers, bandpass filters, channel add devices, channel drop devices, demultiplexers, multiplexers, interleavers, and attenuators.

According to another aspect of the present invention, a method of routing an optical signal through an optical network includes the step of providing the optical signal arranged into a first sub-band combined with a second sub-band. The method continues with separating the optical signal into the first and second sub-bands. The first sub-band routes through a first module and the second sub-band routes through a second module of the same type as the first module. The first and second sub-bands subsequently recombine.

According to another aspect of the present invention, the separating step includes the step of routing the optical signal through an L/C splitter.

According to another embodiment of the present invention, the providing step includes assigning the first sub-band to one of a working path and a protect path and assigning the second sub-band to the other of the working path and protect path.

The routing step, according to one embodiment of the present invention, can include amplifying the first sub-band with the first module and amplifying the second sub-band with the second module.

Other aspects of the present invention include modifying the optical signal in a variety of ways such as filtering, adding channels, dropping channels, demultiplexing, multiplexing, interleaving, or attenuating the optical signals of the first and second sub-bands.

One example embodiment of the present invention includes an optical amplifier node for amplifying an optical signal. The amplifier node has a first amplifier for amplifying only signals from a first sub-band of the optical signal. The signals from the first sub-band are carried only by a working path. A second amplifier amplifies only signals from a second sub-band of the optical signal. The signals from the second sub-band are carried only by a protect path.

A sub-band splitter can split the optical signal into at least two sub-bands, and can be in the form of an L/C splitter. A sub-band combiner can combine at least two sub-bands into the optical signal, and can be in the form of an L/C combiner.

### BRIEF DESCRIPTION OF THE DRAWINGS

The aforementioned features and advantages, and other features and aspects of the present invention, will become better understood with regard to the following description and accompanying drawings, wherein:

FIG. 1A is diagrammatic illustration of a linear transmission system according to known configurations;

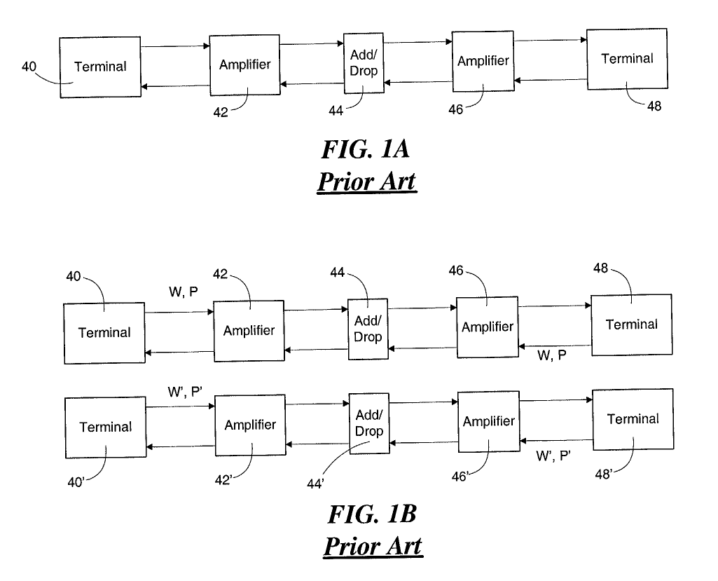

FIG. 1B is a diagrammatic illustration of a linear transmission system with a 1+1 protection scheme according to known configurations;

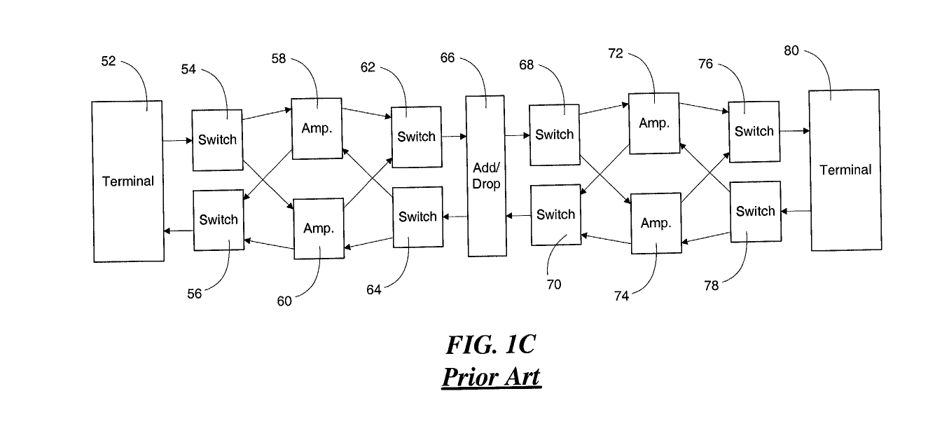

FIG. 1C is a diagrammatic illustration of a linear transmission system with span protection according to known configurations;

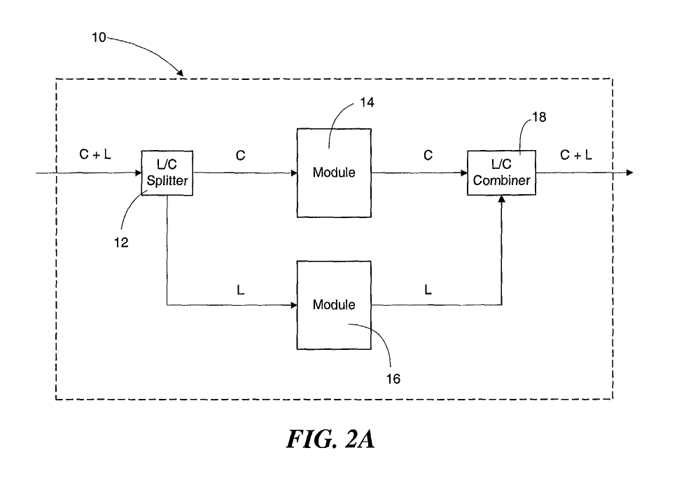

FIGS. 2A & 2B are diagrammatic illustrations of optical sub-assemblies according to aspects of the present invention; and

FIG. 3 is a diagrammatic illustration of a portion of an optical network according to another aspect of the present invention.

### DETAILED DESCRIPTION

The present invention generally relates to an optical network arrangement, wherein working and protect paths are separated not just by wavelength but by sub-band of a full optical band. The sub-bands are routed through separate optical elements during some portions of the optical path. In one embodiment, a first band entirely supports the working path, and a second band entirely supports the protect path. In other embodiments, only certain signals have the working and protect paths routed in this manner.

Conventional optical networks employ a hierarchy of wavelengths organized into bands and sub-bands (e.g., a C-band and L-band structure). The optical network uses up to one hundred sixty wavelengths to transmit data. These wavelengths are divided into two bands, a C-band and an L-band, with eighty wavelengths in each band. The C-band and the L-band and are further divided into an even group, and an odd group, with forty wavelengths in each group. Those skilled in the art will appreciate that the present invention is not limited to an optical network with such a hierarchy. This hierarchy is merely illustrative, and the teachings of the present invention anticipate other hierarchies with different band structures and identifiers.

The existing optical network structures are less likely to require rearranging by splitting and working and protect paths in this, or similar, manner. New elements or modules are likewise not necessary. The working and protect paths further spread the risk of failure of individual modules over multiple modules rather than utilizing, and focusing the risk on, the same modules for the working and protect paths.

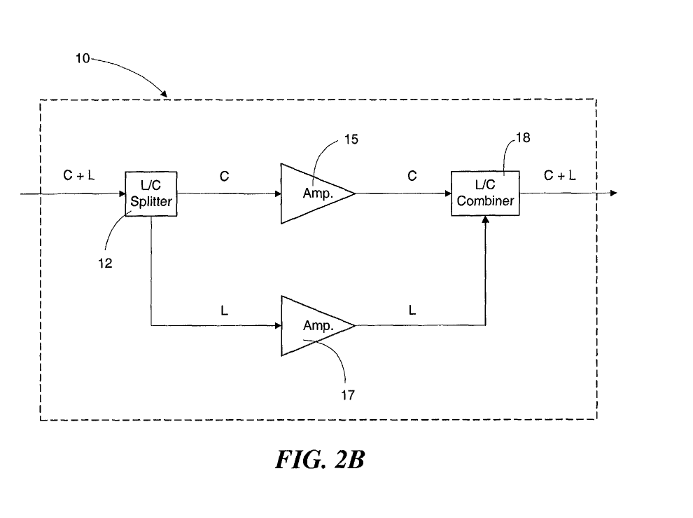

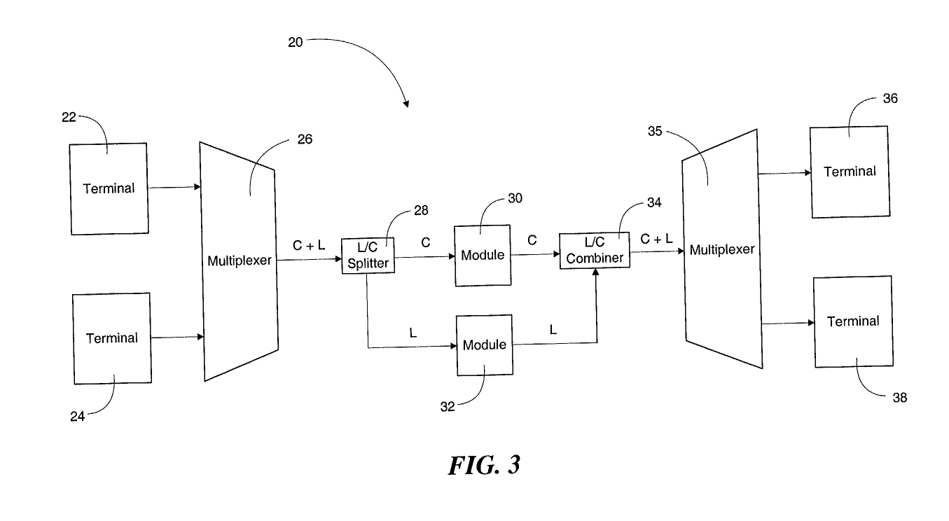

FIGS. 2A, 2B, and 3, wherein like parts are designated by like reference numerals throughout, illustrate example embodiments of an optical network configuration according to the present invention. Although the present invention will be described with reference to the example embodiments illustrated in the figures, it should be understood that many alternative forms can embody the present invention. One of ordinary skill in the art will additionally appreciate different ways to alter the parameters of the embodiments disclosed, such as the size, shape, or type of elements or materials, in a manner still in keeping with the spirit and scope of the present invention.

An optical signal often propagates through an optical network in two sub-bands. These sub-bands are illustrated herein as a C-band and an L-band as previously defined, however the spirit and scope of the present invention is not limited to only these two sub-bands as will be appreciated by one of ordinary skill in the art.

When the optical signal reaches a module that is band dependent, e.g., an amplifier, an L/C splitter splits the optical signal into the C-band and L-band respectively, prior to sending the signal through the particular module. Prior known optical networks include the L/C splitters, but the working and protect paths for a signal propagate within the same sub-band, C-band or L-band. Most often, optical signals propagate through the C-band, while the L-band serves as overflow if there is too much traffic for the C-band to handle. When there is spillover into the L-band, the L-band also supports both working and protect paths.

The working and protect paths are maintained on separate sub-bands as shown in the illustrated embodiments. FIG. 2A illustrates one example sub-assembly 10 of optical components in accordance with aspects of the present invention. An optical signal enters an L/C splitter 12 as a combined C-band and L-band, hereinafter referred to as a “full band”. The L/C splitter 12 splits the full band into a separate C-band and L-band. The C-band continues toward a first module 14, while the L-band proceeds separately toward a second module 16. The first module 14 is of the same type as the second module 16, with the ability to handle a different set of wavelengths if appropriate. The first and second modules 14 and 16 can take the form of any number of different optical components, including optical amplifiers, bandpass filters, channel add devices, channel drop devices, demultiplexers, multiplexers, interleavers, and atttenuators.

The first module 14 manipulates the C-band in the desired manner, while the second module 16 manipulates the L-band in a like manner. The respective C-band and L-band sub-bands proceed to an L/C combiner 18, where the C-band and L-band sub-bands once again combine into a full band. The combined C and L bands, i.e., the full band, proceed onward through the optical network.

Aspects of the present invention teach one of the working path and the protect path carrying entirely the C-band, while the other of the working path and the protect path carrying entirely the L-band. The present illustrative description pairs the working path entirely with the C-band and the protect path entirely with the L-band. However, one of ordinary skill in the art will appreciate that the opposite or reverse configuration can occur. In addition, similar arrangements are possible utilizing an S-band or other sub-band.

The optical signal propagates through the optical sub-assembly 10 of FIG. 2A and the working path and the protect path enter the L/C splitter 12 together as a full band. The working path then separates from the protect path and the working path, and in the form of the C-band propagates through the first module 14, and then the L/C combiner 18. Concomitantly, the protect path, in the form of the L-band, propagates from the L/C splitter 12, passes through the second module 16, and combines again with the working path at the L/C combiner 18 to form the full band. Thus, if the module for the working path (the first module 14) fails, the protect path is not affected. The traffic traveling through the working path diverts to the protect path, and continues through the second module 16, which performs the identical function to the failed first module 14. The traffic continues to the L/C combiner 18 and then through the remainder of the network.

FIG. 2B depicts the optical assembly 10 of FIG. 2A, with the modules 14 and 16 taking the form of amplifiers 15 and 17. An optical signal enters the L/C splitter 12 as a full band. The L/C splitter 12 splits the full band into a separate C-band and L-band. The C-band continues toward a first amplifier 15, while the L-band proceeds separately toward a second amplifier 17. The first amplifier 15 amplifies the C-band signal, while the second amplifier 17 amplifies the L-band signal. The respective C-band and L-band sub-bands proceed to the L/C combiner 18, where the C-band and L-band sub-bands combine into a full band. The combined C and L bands, i.e., the full band, proceed through the optical network.

In the embodiment depicted, the working path carries the C-band in its entirety, and the protect path carries the L-band in its entirety. However, one of ordinary skill in the art will appreciate that the opposite configuration is possible, and that other sub-bands can form each of the separate bands.

The optical signal propagates through the optical sub-assembly 10 of FIG. 2B and the working path and the protect path enter the L/C splitter 12 together as a full band. The working path then separates from the protect path and the working path, via the C-band, propagates through the first amplifier 15, and then the L/C combiner 18. Concomitantly, the protect path, via the L-band, propagates from the L/C splitter 12, through the second amplification 17, and combines again with the working path at the L/C combiner 18 to form the full band. An extension of this technique is to have both amplifiers 15 and 17 operate within the C-band (or other band amplifiers). The splitters then take the form of band-pass, high-pass, and/or low-pass filters or interleavers, such that two distinct paths exist at the node that contain distinct sets of wavelengths and separate optical elements critical to transmission of the optical signal, and subject to failure. The working and protect paths are less likely to both fail when the optical signal is routed through separate optical elements.

FIG. 3 illustrates another optical sub-assembly 20 in accordance with one embodiment of the present invention. In this embodiment, the optical signal enters a multiplexer 26 from a first terminal 22 separate from a second terminal 24. The optical signals from each of the terminals 22 and 26 combine at the multiplexer 26. The signal exiting the multiplexer 26 includes the C-band and the L-band combined as a full band optical signal. The full band enters an L/C splitter 28. The L/C splitter 28 splits the full band optical signal into a C-band and an L-band. Again, the C and L bands are used here merely for illustrative purposes. Note again that the concept of C and L splitters includes other wavelength bands, interleavers, and the like, as understood by one of ordinary skill in the art.

The C-band proceeds through a first module 30, while the L-band proceeds through a second module 32. The first module 30 and the second module 32 are of the same type, and can include amplifiers, bandpass filters, channel add devices, channel drop devices, dispersion compensation modules, demultiplexers, multiplexers, interleavers, and attenuators. The C-band exits the first module 30 and enters an L/C combiner to combine with the L-band, which exits from the second module 32. The full band signal then exits the L/C combiner and continues throughout the optical network as desired.

The C-band of the illustrated embodiment of FIG. 3 is again the sole band carried along the working path of the optical signal, while the L-band is the sole band carried along the protect path of the optical signal. The existence of two modules 14 and 16 or 30 and 32 signifies an existing structure in which multiple optical elements are required to handle the width inherent in the full band signal of a combined C-band and L-band optical signal. If one of the modules in the C-band fails, or likewise an optical fiber, breaks leading to one of the modules in the C-band, the traffic propagating along the working path in the C-band transfers to the protect path in the L-band. Backup or protect modules can then perform the desired functions, without delay of the optical signal traffic.

The present invention teaches the use of only one sub-band, e.g., the C-band or L-band, entirely for propagation along the working path, while using a different sub-band entirely for propagation along the protect path. This configuration separates the working and protect paths by sub-bands rather than by individual wavelengths within a single sub-band. This configuration is advantageous because if a first module 14 or 30 fails on the working path within, e.g., the C-band, the protect path is on a completely separate sub-band, e.g., the L-band, and can proceed through the second module 16 or 32. The first module 14 or 30 performs the same function or functions as the second module 16 or 32.

If any of the optical elements or modules along a working path within an optical network fails, the protect path does not completely fail as well. Instead, the protect path can continue the propagation of the optical signals through the second set of optical elements or modules until the modules or fibers that have failed along the working path can be repaired.

Numerous modifications and alternative embodiments of the invention will be apparent to those skilled in the art in view of the foregoing description. Accordingly, this description is to be construed as illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

What is claimed is:

1. An optical sub-assembly for processing an optical signal, the sub-assembly comprising:
a working path of the optical network;
a first sub-band of the optical signal carried only by the working path;
a protect path of the optical network;
a second sub-band of the optical signal carried only by the protect path;
a first module disposed along the working path for affecting the working path; and
a second module disposed along the protect path for affecting the protect path.

2. The sub-assembly of claim 1, wherein the first sub-band is one of a C-band and an L-band, and the second sub-band is the other of a C-band and an L-band.

3. The sub-assembly of claim 1, wherein the first and second modules are comprised of optical amplifiers.

4. The sub-assembly of claim 1, wherein the first and second modules are comprised of band pass filters.

5. The sub-assembly of claim 1, wherein the first and second modules are comprised of channel add devices.

6. The sub-assembly of claim 1, wherein the first and second modules are comprised of channel drop devices.

7. The sub-assembly of claim 1, wherein the first and second modules are comprised of demultiplexers.

8. The sub-assembly of claim 1, wherein the first and second modules are comprised of multiplexers.

9. The sub-assembly of claim 1, wherein the first and second modules are comprised of interleavers.

10. The sub-assembly of claim 1, wherein the first and second modules are comprised of attenuators.

11. The sub-assembly of claim 1, wherein the first and second modules are comprised of dispersion compensation modules.

12. A method of processing an optical signal in an optical network, comprising the steps of:
separating the optical signal into a first sub-band and a second sub-band;
routing the first sub-band through a first module and routing the second sub-band through a second module of the same type as the first module; and
recombining the first and second sub-bands.

13. The method of claim 12, wherein the separating step comprises the step of routing the optical signal through an L/C splitter.

14. The method of claim 12, further comprising the step of assigning the first sub-band to one of a working path and a protect path and assigning the second sub-band to the other of the working path and protect path.

15. The method of claim 12, wherein the routing step further comprises amplifying the first sub-band with the first module and amplifying the second sub-band with the second module.

16. The method of claim 12, wherein the routing step further comprises filtering the first sub-band with the first module and filtering the second sub-band with the second module.

17. The method of claim 12, wherein the routing step further comprises adding at least one channel to the first sub-band with the first module and adding at least one channel to the second sub-band with the second module.

18. The method of claim 12, wherein the routing step further comprises dropping at least one channel from the first sub-band with the first module and dropping at least one channel from the second sub-band with the second module.

19. The method of claim 12, wherein the routing step further comprises demultiplexing the first sub-band with the first module and demultiplexing the second sub-band with the second module.

20. The method of claim 12, wherein the routing step further comprises multiplexing the first sub-band with the first module and multiplexing the second sub-band with the second module.

21. The method of claim 12, wherein the routing step further comprises interleaving the first sub-band with the first module and interleaving the second sub-band with the second module.

22. The method of claim 12, wherein the routing step further comprises attenuating the first sub-band with the first module and attenuating the second sub-band with the second module.

23. The method of claim 12, wherein the routing step further comprises compensating for dispersion of the first sub-band with the first module and compensating for dispersion of the second sub-band with the second module.

24. An optical amplifier node for amplifying an optical signal, the amplifier node comprising:
a first amplifier for amplifying only signals from a first sub-band of the optical signal, wherein the signals are carried only by a working path; and
a second amplifier for amplifying only signals from a second sub-band of the optical signal, wherein the signals are carried only by a protect path.

25. The optical amplifier node of claim 24, further comprising a sub-band splitter for splitting the optical signal into at least two sub-bands.

26. The optical amplifier node of claim 25, wherein the sub-band splitter is an L/C splitter.

27. The optical amplifier node of claim 24, further comprising a sub-band combiner for combining at least two sub-bands into the optical signal.

28. The optical amplifier node of claim 27, wherein the sub-band combiner is an L/C combiner.
